(19) United States
(12) Patent Application Publication
(10) Pub. No.: US 2025/0183555 A1
(43) Pub. Date: Jun. 5, 2025

(54) ANTENNA MODULE AND COMMUNICATION DEVICE EQUIPPED WITH THE SAME

(71) Applicant: Murata Manufacturing Co., Ltd., Nagaokakyo-shi (JP)

(72) Inventor: Yosuke SATO, Nagaokakyo-shi (JP)

(73) Assignee: Murata Manufacturing Co., Ltd., Nagaokakyo-shi (JP)

(21) Appl. No.: 19/042,047

(22) Filed: Jan. 31, 2025

Related U.S. Application Data
(63) Continuation of application No. PCT/JP2023/015176, filed on Apr. 14, 2023.

(30) Foreign Application Priority Data
Aug. 10, 2022 (JP) 2022-127849

(51) Int. Cl. H01Q 21/06; H01Q 1/22; H01Q 9/04

(52) U.S. Cl. CPC H01Q 21/065; H01Q 1/22; H01Q 9/0414

(57) ABSTRACT

An antenna module includes a dielectric substrate; a first ground electrode and a second ground electrode that are arranged at the dielectric substrate; a plurality of first antenna elements that are arranged in a first direction at the dielectric substrate; and a second antenna element that is arranged at the dielectric substrate. The plurality of first antenna elements face the first ground electrode in a second direction that is different from the first direction. The second antenna element faces the second ground electrode in the second direction. The second antenna element is arranged between first antenna elements that are adjacent to each other, among the plurality of first antenna elements, when seen from a third direction that is orthogonal to the first direction and the second direction.

### CROSS-REFERENCE TO RELATED APPLICATIONS

This is a continuation application of PCT/JP2023/015176, filed on Apr. 14, 2023, designating the United States of America, which is based on and claims priority to Japanese Patent Application No. JP 2022-127849 filed on Aug. 10, 2022. The entire contents of the above-identified applications, including the specifications, drawings and claims, are incorporated herein by reference in their entirety.

### TECHNICAL FIELD

The present disclosure relates to an antenna module and a communication device equipped with the same, and more particularly, to a technique for preventing degradation of antenna gain.

### BACKGROUND ART

Typically, in the case where a plurality of patch antennas are arranged, the relationship between wavelengths of patch antennas and the pitch (center-to-center distance) between patch antennas that are adjacent to each other affects antenna gain. Therefore, it is desirable that a plurality of patch antennas be arranged in such a manner that an optimal pitch can be achieved taking into consideration wavelengths of the patch antennas.

This is also applied to the case where a plurality of stacked patch antennas are arranged. In stacked patch antennas, however, since a plurality of patches with different wavelengths are stacked so as to support a plurality of frequency bands, it is difficult to optimize the pitch between stacked patch antennas that are adjacent to each other.

In U.S. Patent Application Publication No. 2021/0044028 (Patent Document 1), an antenna device including a plurality of stacked patch antennas each in which a first patch corresponding to a first frequency and a second patch corresponding to a second frequency higher than the first frequency are stacked, a second patch being added between stacked patch antennas that are adjacent to each other, is disclosed. In the antenna device described in Patent Document 1, the second patch included in a stacked patch antenna and the second patch added between stacked patch antennas that are adjacent to each other are adjusted to have the same height from a ground plane.

### CITATION LIST

### Patent Document

Patent Document 1: U.S. Patent Application Publication No. 2021/0044028

### SUMMARY OF DISCLOSURE

### Technical Problem

According to the antenna device described in Patent Document 1, by adjusting the pitch between a stacked patch antenna and a second patch added between stacked patch antennas, an optimal pitch can be achieved taking into consideration wavelengths of both the first patch and the second patch. However, in the antenna device described in Patent Document 1, since the opposing distance between the second patch added between the stacked patch antennas that are adjacent to each other and the ground plane is long, a higher-mode surface acoustic wave is generated at the added second patch. As a result, a problem occurs that an antenna gain in the front in a radiation direction of the added second patch only degrades.

The present disclosure has been designed to solve the problem mentioned above, and an object of the present disclosure is to prevent degradation of an antenna gain in an antenna module in which a second antenna element including a third radiating element is arranged between first antenna elements that are adjacent to each other among a plurality of first antenna elements each in which a first radiating element and a second radiating element that are different in size are stacked.

### Solution to Problem

An antenna module according to a first aspect of the present disclosure includes a dielectric substrate; a first ground electrode and a second ground electrode that are arranged at the dielectric substrate; a plurality of first antenna elements that are arranged in a first direction at the dielectric substrate; and a second antenna element that is arranged at the dielectric substrate. The plurality of first antenna elements face the first ground electrode in a second direction that is different from the first direction. The second antenna element faces the second ground electrode in the second direction. The second antenna element is arranged between first antenna elements that are adjacent to each other, among the plurality of first antenna elements, when seen from a third direction that is orthogonal to the first direction and the second direction. Each of the first antenna elements that are adjacent to each other includes a first radiating element and a second radiating element that is arranged between the first radiating element and the first ground electrode. The second antenna element includes a third radiating element. The first radiating element, the second radiating element, and the third radiating element each have a flat plate shape. In the first direction, a size of the second radiating element is larger than a size of the first radiating element. An opposing distance between the third radiating element and the second ground electrode is shorter than an opposing distance between the first radiating element and the first ground electrode.

### Advantageous Effects of Disclosure

According to the present disclosure, degradation of antenna gain can be prevented in an antenna module in which a second antenna element including a third radiating element is arranged between first antenna elements that are adjacent to each other among a plurality of first antenna elements each in which a first radiating element and a second radiating element that are different in size are stacked.

### BRIEF DESCRIPTION OF DRAWINGS

FIG. 1 is a block diagram of a communication device in which an antenna module according to a first embodiment is used.

FIG. 2 includes a plan view and a side perspective view of the antenna module in FIG. 1.

FIG. 3 includes a plan view and a side perspective view of an antenna module according to a second embodiment.

FIG. 4 includes a plan view and a side perspective view of an antenna module according to a third embodiment.

FIG. 5 includes a plan view and a side perspective view of an antenna module according to a fourth embodiment.

FIG. 6 is a plan view of an antenna module according to a fifth embodiment.

FIG. 7 includes a plan view and a side perspective view of an antenna module according to a sixth embodiment.

### DESCRIPTION OF EMBODIMENTS

Hereinafter, embodiments of the present disclosure will be described in detail with reference to drawings. The same or corresponding parts in drawings are denoted by the same signs, and repetitive description of those parts will not be provided.

### First Embodiment

### (Basic Configuration of Communication Device)

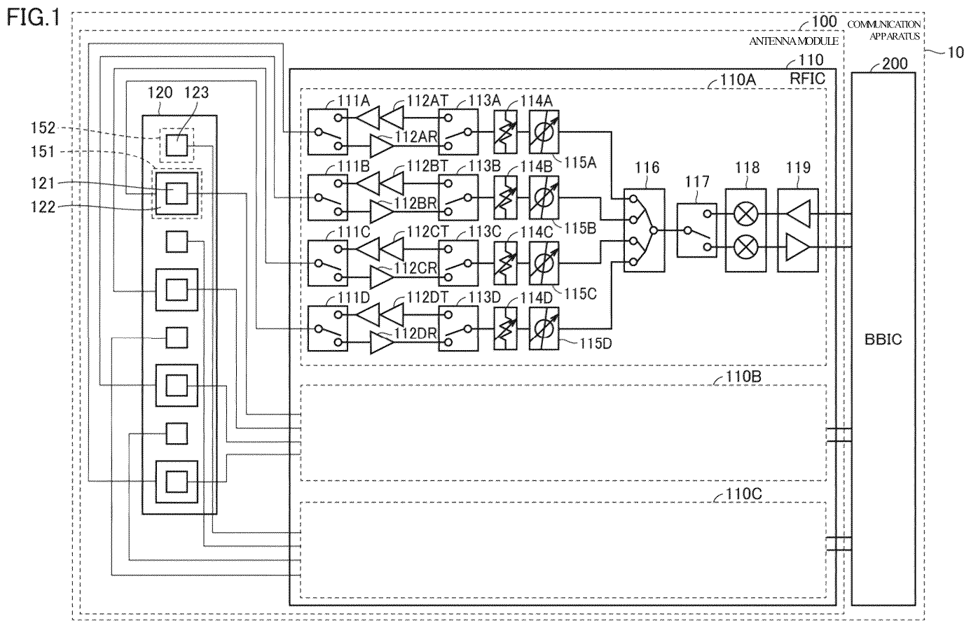

FIG. 1 is an example of a block diagram of a communication device 10 in which an antenna module 100 according to a first embodiment is used. The communication device 10 is, for example, a portable terminal such as a mobile phone, a smartphone, or a tablet, a personal computer provided with a communication function, or the like. Examples of frequency bands of radio waves used in the antenna module 100 according to the first embodiment include radio waves in millimeter wave bands with center frequencies of 28 GHz, 60 GHz, and the like. However, radio waves in other frequency bands can also be used in an antenna module according to the present disclosure.

Referring to FIG. 1, the communication device 10 includes the antenna module 100 and a BBIC 200 that configures a baseband signal processing circuit. The antenna module 100 includes an RFIC 110, which is an example of a power feed device, and an antenna device 120. The communication device 10 up-converts, in the RFIC 110, a signal transmitted from the BBIC 200 to the antenna module 100 into a high frequency signal and radiates the high frequency signal from the antenna device 120. The communication device 10 also transmits a high frequency signal received by the antenna device 120 to the RFIC 110, down-converts the high frequency signal, and causes the signal to be processed at the BBIC 200.

The antenna module 100 is an antenna module of a so-called multiband type that is capable of radiating radio waves in two different types of frequency bands. The antenna device 120 includes antenna elements 151 and 152.

The antenna elements 151 each include radiating elements 121 and 122. The antenna elements 152 each include a radiating element 123. In the first embodiment, each of the radiating elements 121, 122, and 123 is a patch antenna having a flat plate shape. The radiating elements 122 radiate radio waves in a first frequency band. The radiating elements 121 and 123 radiate radio waves in a second frequency band. For example, the first frequency band is 60 GHZ, and the second frequency band is 28 GHZ.

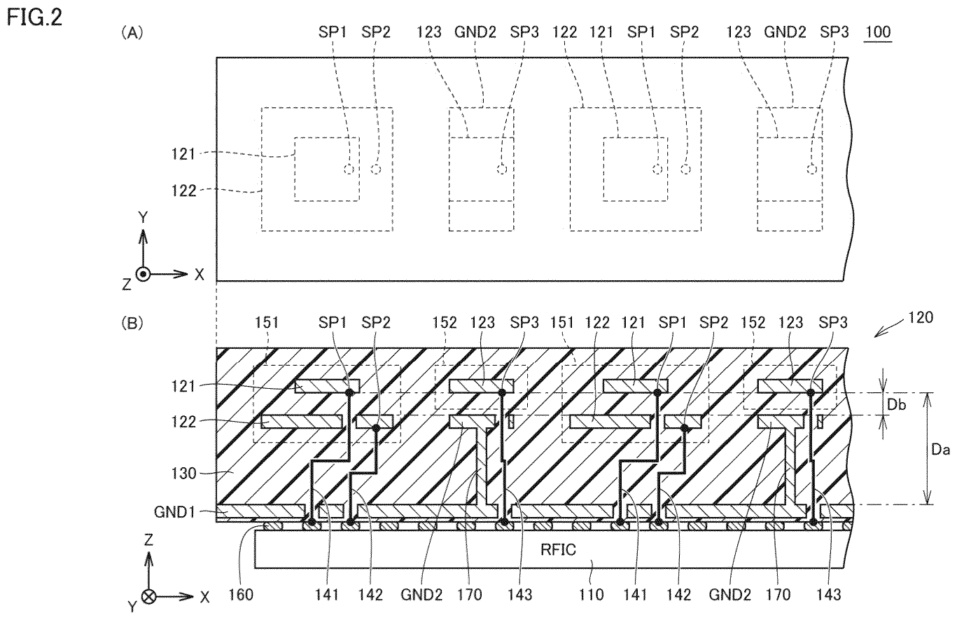

The antenna elements 151 each include a stacked patch antenna in which the radiating element 121 and the radiating element 122 are stacked. The antenna elements 152 each include a radiating element 123 only. The antenna elements 151 and the antenna elements 152 are arranged alternately in one direction at a dielectric substrate 130 (see FIG. 2) of the antenna device 120.

In FIG. 1, an example in which the antenna elements 151 and 152 are arranged in a line to form a one-dimensional array is illustrated. Instead of this arrangement, the antenna elements 151 and 152 may be arranged in a two-dimensional array.

The RFIC 110 includes power feed circuits corresponding to the radiating elements 121 to 123. Specifically, the RFIC 110 includes a power feed circuit 110A corresponding to the radiating elements 121, a power feed circuit 110B corresponding to the radiating elements 122, and a power feed circuit 110C corresponding to the radiating elements 123. A power feed circuit may be provided for each frequency band of a radiating element. For example, in the case where the radiating elements 122 radiate radio waves in the first frequency band (60 GHZ) and the radiating elements 121 and 123 radiate radio waves in the second frequency band (28 GHz), a power feed circuit corresponding to the radiating elements 122 and a power feed circuit corresponding to the radiating elements 121 and 123 may be provided.

The power feed circuit 110A includes switches 111A to 111D, 113A to 113D and 117, power amplifiers 112AT to 112DT, low noise amplifiers 112AR to 112DR, attenuators 114A to 114D, phase shifters 115A to 115D, a signal combiner/splitter 116, a mixer 118, and an amplifier circuit 119.

In the case where a high frequency signal is transmitted, the switches 111A to 111D and 113A to 113D are switched toward the power amplifiers 112AT to 112DT and the switch 117 is connected to a transmission-side amplifier of the amplifier circuit 119. In the case where a high frequency signal is received, the switches 111A to 111D and 113A to 113D are switched toward the low noise amplifiers 112AR to 112DR and the switch 117 is connected to a reception-side amplifier of the amplifier circuit 119.

A signal transmitted from the BBIC 200 is amplified by the amplifier circuit 119 and is up-converted by the mixer 118. A transmission signal, which is an up-converted high frequency signal, is split into four signals by the signal combiner/splitter 116. The signals travel through four signal paths and are fed to different radiating elements 121. At this time, since the degrees of phase shift at the phase shifters 115A to 115D arranged on corresponding signal paths are adjusted separately, the directivity of the antenna device 120 can be adjusted. Furthermore, the attenuators 114A to 114D adjust strengths of transmission signals.

Reception signals, which are high frequency signals received at the individual radiating elements 121, travel through different four signal paths and are combined together at the signal combiner/splitter 116. The combined reception signal is down-converted by the mixer 118, is amplified by the amplifier circuit 119, and is transmitted to the BBIC 200.

The configuration of each of the power feed circuits 110B and 110C is similar to the configuration of the power feed circuit 110A. For an easier explanation, in FIG. 1, illustration of the detailed configuration of the power feed circuits 110B and 110C is omitted.

The RFIC 110 is formed as, for example, a single-chip integrated circuit component including the circuit configuration mentioned above. Alternatively, the RFIC 110 may be formed as integrated circuit components for individual power feed circuits. Furthermore, as devices (a switch, a power amplifier, a low noise amplifier, an attenuator, and a phase shifter) corresponding to each radiating element, a single-chip integrated circuit component may be formed for the corresponding radiating element.

### (Structure of Antenna Module)

Next, the details of a configuration of the antenna module 100 according to the first embodiment will be described with reference to FIG. 2. FIG. 2 is a diagram illustrating the antenna module 100 according to the first embodiment. In FIG. 2, a plan view of the antenna module 100 is illustrated in an upper part (FIG. 2(A)), and a side perspective view of the antenna module 100 is illustrated in a lower part (FIG. 2(B)).

The antenna module 100 also includes a dielectric substrate 130, power feed wires 141, 142, and 143, and ground electrodes GND1 and GND2, in addition to the antenna elements 151 each including the radiating elements 121 and 122, the antenna elements 152 each including the radiating element 123, and the RFIC 110.

In the description provided below, a normal direction of the dielectric substrate 130 (radiation direction of a radio wave) is defined as a Z-axis direction. Furthermore, on a plane perpendicular to the Z-axis direction, a direction in which the antenna elements 151 and 152 are arranged is defined as an X axis, and a direction orthogonal to the X axis is defined as a Y axis. Furthermore, in each drawing, a Z-axis positive direction may be referred to as an upper side, and a Z-axis negative direction may be referred to as a lower side.

The dielectric substrate 130 is, for example, a low temperature co-fired ceramics (LTCC) multilayer substrate, a multilayer resin substrate formed by laminating multiple resin layers made of resin such as epoxy or polyimide, a multilayer resin substrate formed by laminating multiple resin layers made of liquid crystal polymer (LCP) having a lower permittivity, a multilayer resin substrate formed by laminating multiple resin layers made of fluorine-based resin, a multilayer resin substrate formed by laminating multiple resin layers made of a polyethylene terephthalate (PET) material, or a ceramics multilayer substrate made of a material other than LTCC. The dielectric substrate 130 does not necessarily have a multilayer structure and may be a single-layer substrate.

The dielectric substrate 130 has a rectangular shape when seen in plan view from the normal direction (Z-axis direction). The ground electrode GND1 is arranged at a position close to the lower surface of the dielectric substrate 130 over the entire dielectric substrate 130. The ground electrodes GND2 are connected to the ground electrode GND1 with via conductors 170 interposed therebetween. In the Z-axis direction, the ground electrode GND1 and the ground electrodes GND2 face each other. Inside the dielectric substrate 130, the antenna elements 151 and the antenna elements 152 are arranged alternately in the X-axis direction with predetermined pitches therebetween.

The antenna elements 151 each include a stacked patch antenna in which the radiating elements 121 and 122 are stacked in the Z-axis direction. The antenna elements 152 each include the radiating element 123. Out of the radiating elements 121 and 122, the radiating elements 121 are arranged at positions close to the upper surface (a surface in the Z-axis positive direction) of the dielectric substrate 130. The radiating elements 122 are arranged between the radiating elements 121 and the ground electrode GND1. In the case where the dielectric substrate 130 is seen in plan view from the normal direction (Z-axis direction), the radiating elements 122 and the radiating elements 121 overlap. The radiating elements 121 are arranged at positions facing the ground electrode GND1 with a distance Da therebetween.

In the first embodiment, in the case where the dielectric substrate 130 is seen from the Z-axis direction, the center of an antenna element 152 (radiating element 123) is located on a line connecting the centers of antenna elements 151 (centers of radiating elements 121 and 122) that are adjacent to each other.

At the dielectric substrate 130, the distance from the radiating elements 123 to the lower surface of the dielectric substrate 130 and the distance from the radiating elements 121 to the lower surface of the dielectric substrate 130 are the same. At the dielectric substrate 130, the opposing distance between the radiating elements 121 and the ground electrode GND1 and the opposing distance between the radiating elements 123 and the ground electrode GND1 are the same (opposing distance=Da). The radiating elements 123 and the ground electrodes GND2 face each other with a distance Db therebetween.

The radiating elements 121 and 123 may be arranged so as to be exposed to a surface of the dielectric substrate 130 or may be arranged inside the dielectric substrate 130.

Each of the radiating elements 122, 121, and 123 is a flat-plate-shape electrode with a rectangular shape. The size of a radiating element 121 is the same as the size of a radiating element 123. Therefore, the resonant frequency of the radiating element 121 and the resonant frequency of the radiating element 123 are the same. The size of a radiating element 122 is larger than the size of each of the radiating elements 121 and 123. More specifically, in the X-axis direction and the Y-axis direction, the size of the radiating element 122 is twice or more than twice the size of each of the radiating elements 121 and 123. Therefore, the resonant frequencies of the radiating elements 121 and 123 are higher than the resonant frequency of the radiating element 122. That is, the frequency band of radio waves radiated from the radiating elements 121 and 123 is higher than the frequency band of a radio wave radiated from the radiating element 122.

In the first embodiment, the center frequency of the frequency band of the radiating elements 121 and 123 is 28 GHz and the center frequency of the frequency band of the radiating elements 122 is 60 GHZ.

The ground electrodes GND2 are flat-plate-shape electrodes with a rectangular shape, as with the radiating elements 121, 122, and 123. The size in the X-axis direction of each of the ground electrodes GND2 and the size in the X-axis direction of each of the radiating elements 121 and 123 are the same. The size in the Y-axis direction of each of the ground electrodes GND2 is larger than the size in the Y-axis direction of each of the radiating elements 121 and 123 and is the same as the size in the Y-axis direction of the radiating element 122.

High frequency signals are supplied from the RFIC 110 through the power feed wires 141, 142, and 143 to the radiating elements 121, 122, and 123, respectively. The power feed wires 141 extend from the RFIC 110, penetrate through the ground electrode GND1 and the radiating elements 122, and are connected to power feed points SP1 of the radiating elements 121. The power feed wires 142 extend from the RFIC 110, penetrate through the ground electrode GND1, and are connected to power feed points SP2 of the radiating elements 122. The power feed wires 143 extend from the RFIC 110, penetrate through the ground electrodes GND1 and GND2, and are connected to power feed points SP3 of the radiating elements 123.

The power feed points SP1 are offset in the X-axis positive direction from the center of the radiating elements 121. The power feed points SP2 are offset in the X-axis positive direction from the center of the radiating elements 122. The power feed points SP3 are offset in the X-axis positive direction from the center of the radiating elements 123. Thus, radio waves that are polarized in the X-axis direction are radiated from the radiating elements 122, 121, and 123.

The RFIC 110 is mounted on the lower surface of the dielectric substrate 130 with solder bumps 160 interposed therebetween. The RFIC 110 may be connected to the dielectric substrate 130 by a multi-pole connector instead of solder connection.

In the case where a plurality of patch antennas are arranged in an array, an optimal pitch (center-to-center distance) between patch antennas is typically about 0.4 to 0.8 times the space wavelength λ0. Assuming patch antennas are arranged with pitches other than optimal pitches therebetween, decrease of antenna gain, generation of a grating lobe, or the like may occur. Thus, antenna gain may degrade. Therefore, also in the case where stacked patch antennas such as the antenna elements 151 are arranged, it is important to achieve optimal pitches.

However, in stacked patch antennas, a plurality of radiating elements with different sizes are stacked in order to support a plurality of frequency bands. The wavelength of a radio wave radiated from a radiating element that is relatively small in size is shorter than the wavelength of a radio wave radiated from a radiating element that is relatively large in size. Accordingly, an optimal pitch for radiating elements with a smaller size and an optimal pitch for radiating elements with a larger size are not the same. Therefore, it is difficult to optimize the pitch between stacked patch antennas that are adjacent to each other.

In the case where a radiating element that radiates a radio wave with a relatively short wavelength is referred to as a high frequency patch and a radiating element that radiates a relatively long wavelength is referred to as a low frequency patch, in a region where “frequency of a high frequency patch≥frequency of low frequency patch×1.8” is satisfied, a degradation of antenna gain is typically significant.

Thus, in the first embodiment, an antenna element 152 including a radiating element 123 is arranged between antenna elements 151 that are adjacent to each other. Accordingly, as illustrated in FIG. 2, at the dielectric substrate 130, an arrangement in which the radiating elements 121 and 123 configuring high frequency patches are arranged alternately with pitches optimal for the high frequency patches therebetween and the radiating elements 122 configuring low frequency patches are arranged with pitches optimal for the low frequency patches therebetween, the antenna element 152 (radiating element 123) being interposed between the radiating elements 122, can be achieved. With this arrangement, pitches for the radiating elements 121 and the radiating elements 123 configuring the high frequency patches can be optimized, and at the same time, pitches for the radiating elements 122 and 122 configuring the low frequency patches can be optimized.

Moreover, in the first embodiment, the ground electrodes GND2 that face the radiating elements 123 are provided at positions closer to the radiating elements 123 than the ground electrode GND1 is to the radiating elements 123 in the dielectric substrate 130. That is, the opposing distance Db between the radiating elements 123 and the ground electrodes GND2 is shorter than the opposing distance Da between the radiating elements 121 and the ground electrode GND1 (distance Db<distance Da). In this embodiment, a so-called arrangement in which the positions of the ground electrodes that face the radiating elements 123 are moved closer to the radiating elements 123 from the position of the ground electrode GND1 is adopted.

Therefore, compared to the arrangement in which the radiating elements 123 face the ground electrode GND1 near the lower surface of the dielectric substrate 130 without the ground electrodes GND2 being provided, generation of higher-mode surface acoustic waves in the radiating elements 123 can be prevented. As a result, adverse influence on the antenna gain of the entire antenna module 100 by degradation of the antenna gain in the front in the radiation direction of the radiating elements 123 can be prevented.

In the first embodiment, the opposing distance between the radiating elements 121 and the ground electrode GND1 and the opposing distance between the radiating elements 123 and the ground electrode GND1 are the same. However, the opposing distance between the radiating elements 121 and the ground electrode GND1 may be made different from the opposing distance between the radiating elements 123 and the ground electrode GND1. For example, one of the radiating elements 121 and the radiating elements 123 may be arranged at positions closer to the upper surface of the dielectric substrate 130 than the other one of the radiating elements 121 and the radiating elements 123 are. That is, a plurality of high frequency patches including the radiating elements 121 and 123 are not necessarily arranged on the same plane assuming the dielectric substrate 130 is seen from the Y-axis direction.

In the case where the dielectric substrate 130 is seen from the Y-axis direction, the radiating elements 121 are not necessarily arranged on the same plane. In the case where the dielectric substrate 130 is seen from the Y-axis direction, the radiating elements 123 are not necessarily arranged on the same plane.

In the first embodiment, in the case where the dielectric substrate 130 is seen from the Y-axis direction, the opposing distance between the radiating elements 122 and the ground electrode GND1 and the opposing distance between the ground electrodes GND2 and the ground electrode GND1 are the same. However, in the present disclosure, the opposing distance between the radiating elements 122 and the ground electrode GND1 only needs to be equal to or longer than the opposing distance between the ground electrodes GND2 and the ground electrode GND1.

In the first embodiment, the ground electrodes GND2 are connected to the ground electrode GND1 with the via conductors 170 interposed therebetween. However, the ground electrodes GND2 may be part of the ground electrode GND1 that faces the radiating elements 123. In this case, by making the thickness in the Z-axis direction of the part of the ground electrode GND1 that faces the radiating element 123 larger than the other parts of the ground electrode GND1, the opposing distance Db between the ground electrodes GND2 and the radiating elements 123 can be achieved, as illustrated in FIG. 2.

In the first embodiment, in the case where the dielectric substrate 130 is seen from the Z-axis direction, the center of an antenna element 152 (radiating element 123) is located on a line connecting the centers of antenna elements 151 (centers of radiating elements 121 and 122) that are adjacent to each other. This means that the antenna element 152 is arranged between antenna elements 151 that are adjacent to each other.

However, in order to arrange an antenna element 152 between antenna elements 151 that are adjacent to each other, the center of the antenna element 152 (radiating element 123) is not necessarily located on a line connecting the centers of the antenna elements 151 (centers of the radiating elements 121 and 122) that are adjacent to each other. The center of the antenna element 152 (radiating element 123) may be arranged out of the line. In the present disclosure, each of the antenna elements 152 only needs to be arranged between antenna elements 151 that are adjacent to each other among the plurality of antenna elements 151 when seen from the Y-axis direction.

In the first embodiment, the ground electrode GND1 is an example of a first ground electrode, the ground electrodes GND2 are an example of second ground electrodes, the antenna elements 151 are an example of first antenna elements, and the antenna elements 152 are an example of second antenna elements.

In the first embodiment, the X-axis direction is an example of a first direction, the Z-axis direction is an example of a second direction, and the Y-axis direction is an example of a third direction. In the first embodiment, 28 GHZ, which is the center frequency of the frequency band of the radiating elements 122, is an example of a first frequency band, and 60 GHZ, which is the center frequency of the frequency band of the radiating elements 121 and 123, is an example of a second frequency band, which is higher than the first frequency band.

### Second Embodiment

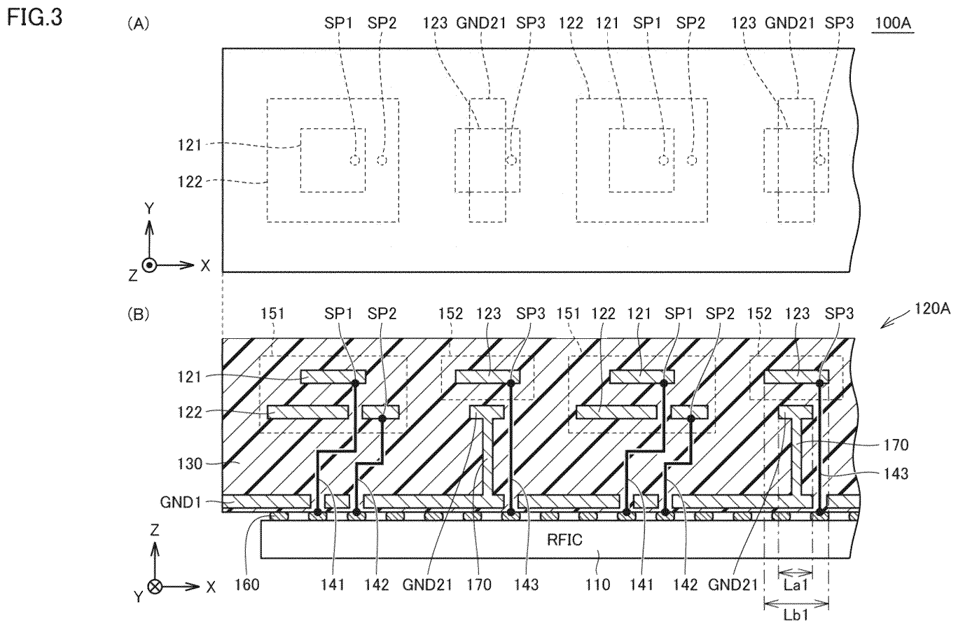

FIG. 3 includes a plan view and a side perspective view of an antenna module 100A according to a second embodiment. In FIG. 3, a plan view of the antenna module 100A is illustrated in an upper part (FIG. 3(A)), and a side perspective view of the antenna module 100A is illustrated in a lower part (FIG. 3(B)). The antenna module 100A includes the RFIC 110 and an antenna device 120A.

The antenna module 100A according to the second embodiment is different from the antenna module 100 according to the first embodiment in the shape of ground electrodes that face the radiating elements 123. In the antenna module 100A, the radiating elements 123 face ground electrodes GND21. The ground electrodes GND21 of the antenna module 100A are smaller in size in the X-axis direction than that of the ground electrodes GND2 of the antenna module 100. More specifically, in the X-axis direction, the size of the ground electrodes GND21 is smaller than the size of the radiating elements 123. As illustrated in FIG. 3, the relationship La1<Lb1 is met, where the size of the ground electrodes GND21 in the X-axis direction is represented by La1 and the size of the radiating elements 123 in the X-axis direction is represented by Lb1.

As illustrated in FIG. 3, a radiating element 122 configuring part of an antenna element 151 is arranged at each side of a ground electrode GND21. By making the size of the ground electrode GND21 in the X-axis direction smaller than the size of the ground electrode GND2 in the first embodiment, impact on radiation of a radio wave from the radiating element 122 can be reduced. As a result, degradation of an antenna gain in the radiating element 122 functioning as a low frequency patch of the antenna element 151 due to the ground electrode GND21 provided between antenna elements 151 that are adjacent to each other can be suppressed.

The configuration of the antenna module 100A is the same as the configuration of the antenna module 100 with the exception of the ground electrodes GND21. Therefore, detailed description of the other configuration features of the antenna module 100A will not be repeated here.

### Third Embodiment

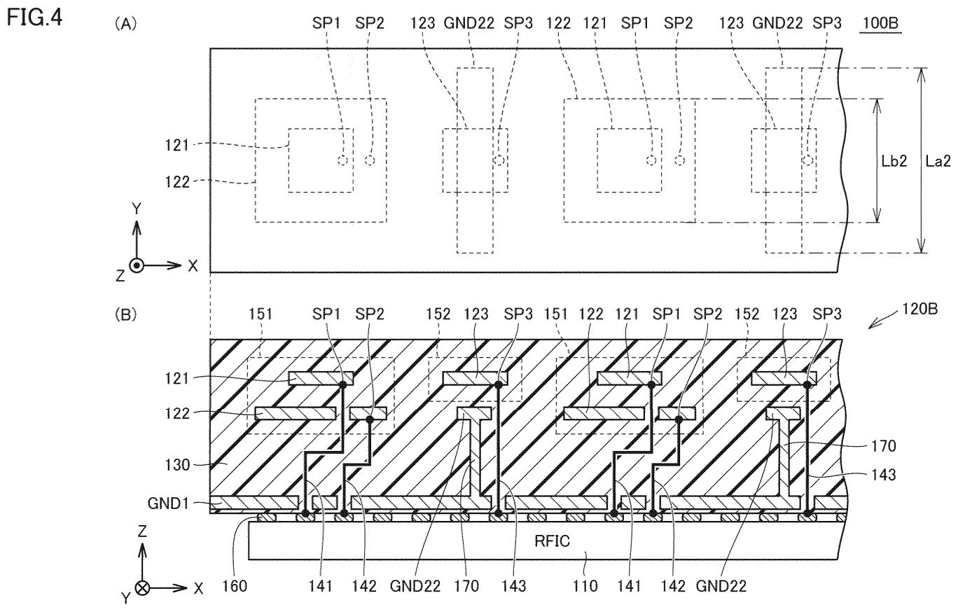

FIG. 4 includes a plan view and a side perspective view of an antenna module 100B according to a third embodiment. In FIG. 4, a plan view of the antenna module 100B is illustrated in an upper part (FIG. 4(A)), and a side perspective view of the antenna module 100B is illustrated in a lower part (FIG. 4(B)). The antenna module 100B includes the RFIC 110 and an antenna device 120B.

As described above as the second embodiment, the effect that degradation of an antenna gain in the radiating elements 122 is suppressed by reducing the size in the X-axis direction of ground electrodes, such as the ground electrodes GND21, that face the radiating elements 123 can be achieved. However, as a result, the surface area of the ground electrodes GND21 assuming the dielectric substrate 130 is seen from the Z-axis direction is smaller than the surface area of the ground electrodes GND2 assuming the dielectric substrate 130 is seen from the Z-axis direction. Consequently, the antenna gain of the radiating elements 123 decreases.

Thus, in the antenna module 100B according to the third embodiment, while the size in the X-axis direction of the ground electrodes that face the radiating elements 123 is reduced as in the antenna module 100A according to the second embodiment, the size in the Y-axis direction of the ground electrodes is increased. More specifically, the relationship of La2>Lb2 is met, where the size in the Y-axis direction of ground electrodes GND22 is represented by La2 and the size in the Y-axis direction of the radiating elements 122 is represented by Lb2. As described above, in the third embodiment, in the Y-axis direction, the size of the ground electrodes GND22 that face the radiating elements 123 is larger than the size of the radiating elements 122.

According to the third embodiment, by making the surface area of the ground electrodes GND22 larger than that of the ground electrodes GND21 while suppressing an adverse impact of the ground electrodes GND22 on radiation of radio waves from the radiating elements 122, the antenna gain of the radiating elements 123 can be increased.

The configuration of the antenna module 100B is the same as the configuration of the antenna module 100 with the exception of the ground electrodes GND22. Therefore, detailed description of the other configuration features of the antenna module 100B will not be repeated here.

### Fourth Embodiment

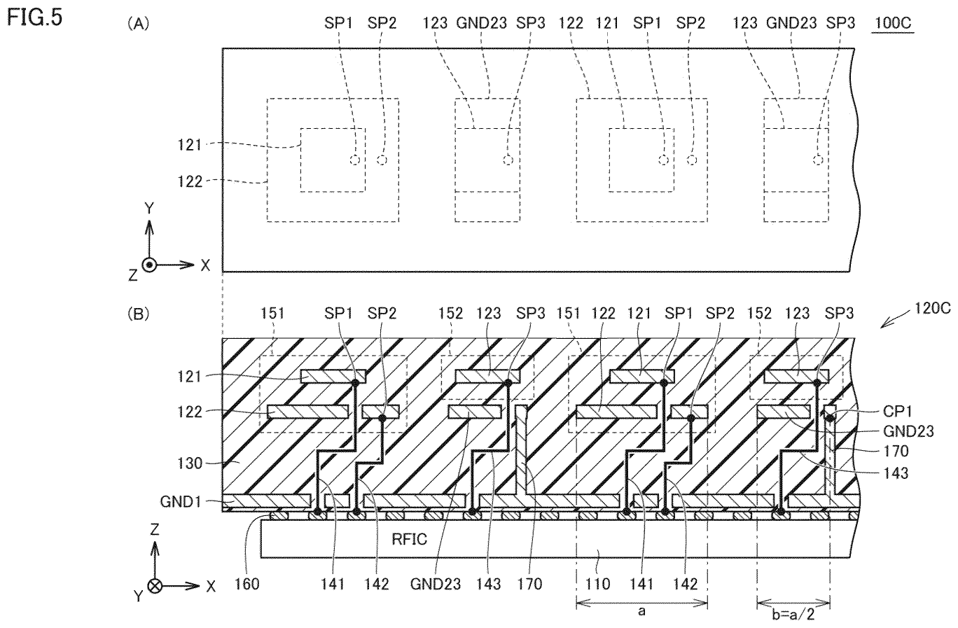

FIG. 5 includes a plan view and a side perspective view of an antenna module 100C according to a fourth embodiment. In FIG. 5, a plan view of the antenna module 100C is illustrated in an upper part (FIG. 5(A)), and a side perspective view of the antenna module 100C is illustrated in a lower part (FIG. 5(B)). The antenna module 100C includes the RFIC 110 and an antenna device 120C.

The antenna module 100C according to the fourth embodiment has a feature found in the positions of the via conductors 170 connected to ground electrodes facing the radiating elements 123, compared to the antenna module 100 according to the first embodiment. In the antenna module 100C, the radiating elements 123 face ground electrodes GND23. Connection parts CP1 of the ground electrodes GND23 are connected to the via conductors 170.

As illustrated in FIG. 5, assuming the size in the X-axis direction of a radiating element 122 is represented by a and the distance in the X-axis direction between an end portion of a ground electrode GND23 and a connection part CP1 is represented by b, the size and the distance b have a relationship “b=a/2”.

In the fourth embodiment, with the arrangement described above, the isolation between radiating elements (low frequency patches) 122 that are adjacent to each other with a radiating element 123 interposed therebetween can be ensured. Assuming the radiating element 122 is excited by radiation of a radio wave, the ground electrode GND1 that is arranged to face the radiating element 122 is also excited, and an excitation signal is generated at the ground electrode GND1. The excitation signal affects the antenna gain of other radiating elements 122 that face the ground electrode GND1.

Thus, in the fourth embodiment, the ground electrode GND23 that is arranged between the radiating elements 122 that are adjacent to each other is caused to function as a shield wall for shielding an excitation signal. Typically, due to excitation of the radiating element 122, an excitation signal of a wave form defined by the wavelength A of a radio wave radiated from the radiating element 122 is generated in the ground electrode GND1. This excitation signal propagates through the ground electrode GND1 and the via conductor 170 and reaches, via the connection part CP1, the ground electrode GND23. The excitation signal propagated to the ground electrode GND23 turns back at the end portion of the ground electrode GND23 in the X-axis direction and returns to the connection part CP1. Thus, in the ground electrode GND23, an excitation signal traveling from the connection part CP1 to the end portion of the ground electrode GND23 and an excitation signal returning from the end portion of the ground electrode GND23 to the connection part CP1 interfere with each other.

In the fourth embodiment, the distance b from the connection part CP1 to the end portion of the ground electrode GND23 is set to be “½” the size a in the X-axis direction of the radiating element 122. The wavelength of a radio wave radiated from the radiating element 122 is “½” the size a of the radiating element 122. Thus, the distance b from the connection part CP1 to the end portion of the ground electrode GND23 corresponds to “¼” the wavelength of a radio wave radiated from the radiating element 122.

In the case where the distance from the connection part CP1 to the end portion of the ground electrode GND23 is set as described above, the phase of an excitation signal returning from the end portion of the ground electrode GND23 to the connection part CP1 is the same as the phase obtained by inverting the phase of an excitation signal traveling from the connection part CP1 to the end portion of the ground electrode GND23. Thus, the excitation signal traveling from the connection part CP1 to the end portion of the ground electrode GND23 and the excitation signal returning from the end portion of the ground electrode GND23 to the connection part CP1 cancel each other out. As a result, an excitation signal generated in the ground electrode GND1 by excitation at one of radiating elements 122 that are adjacent to each other with the ground electrode GND23 interposed therebetween can be prevented from propagating to the other one of the radiating elements 122.

As described above, in the fourth embodiment, the ground electrode GND23 arranged between radiating elements 122 that are adjacent to each other functions as a shield wall for an excitation signal. Thus, the isolation between the radiating elements 122 that are adjacent to each other with the radiating element 123 interposed therebetween can be ensured. Consequently, the antenna gain in the radiating elements 122 can be improved.

The example in which the distance b in the X-axis direction between the end portion of the ground electrode GND23 and the connection part CP1 is set to be “½” the size a in the X-axis direction of the radiating element 122 has been described above. In this case, the distance b corresponds to “¼” the wavelength of a radio wave radiated from the radiating element 122. That is, in the fourth embodiment, by setting the distance b to be “¼” the wavelength of a radio wave radiated from the radiating element 122, excitation signals generated at GND1 can be canceled out.

However, the effect such as canceling or reducing excitation signals generated at GND1 is not necessarily achieved in the case where the distance b is set to be “¼” the wavelength of a radio wave radiated from the radiating element 122. For example, also in the case where the distance b is set to be “⅛” or more and “⅜” or less the wavelength of a radio wave radiated from the radiating element 122, the effect such as canceling or reducing excitation signals generated at GND1 can be achieved. In other words, also in the case where the distance b is set to be “¼” or more and “¾” or less the size a of the radiating element 122, the effect such as canceling or reducing excitation signals generated at GND1 can be achieved. Thus, the distance b in the X-axis direction between the end portion of the ground electrode GND23 and the connection part CP1 only needs to be “¼” or more and “¾” or less the size a in the X-axis direction of the radiating element 122.

The configuration of the antenna module 100C is the same as the configuration of the antenna module 100 with the exception of the ground electrodes GND23. Therefore, detailed description of the other configuration features of the antenna module 100C will not be repeated here.

### Fifth Embodiment

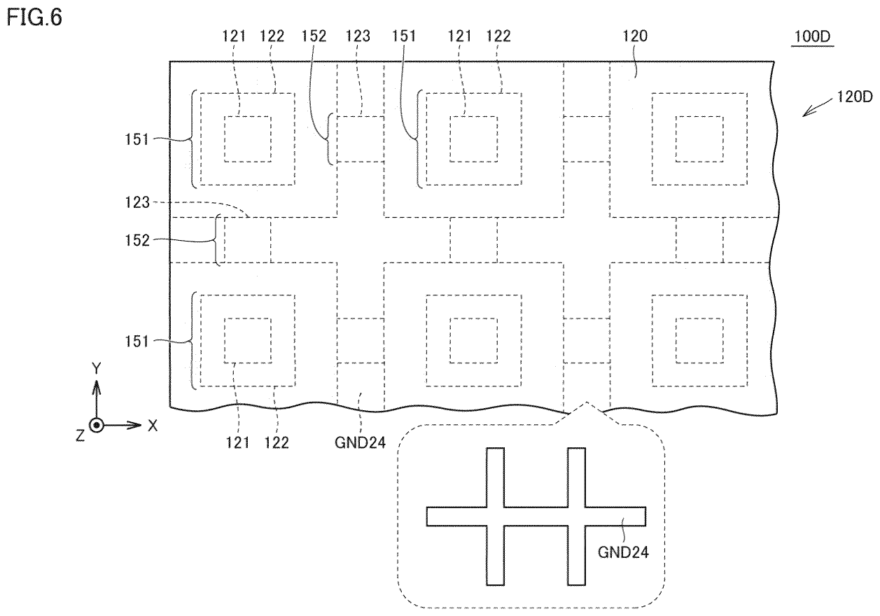

FIG. 6 is a plan view of an antenna module 100D according to a fifth embodiment. The antenna module 100D includes the RFIC 110 and an antenna device 120D. In FIG. 6, illustration of the RFIC 110 is omitted.

In the antenna module 100D according to the fifth embodiment, the antenna elements 151 and 152 are arranged in a two-dimensional array in the X-axis direction and the Y-axis direction. As mentioned above, in the fifth embodiment, antenna elements 151 that are adjacent to each other and an antenna element 152 arranged between the antenna elements 151 that are adjacent to each other are arranged in an array in the X-axis direction and the Y-axis direction at the dielectric substrate 130. Since the antenna elements 151 and 152 are arranged in a two-dimensional array, the total amount of energy as an array antenna can be increased.

Furthermore, in the antenna module 100D, a ground electrode GND24 that faces the individual radiating elements 123 is configured in an integrated manner, as supplementarily indicated within a broken line frame. More specifically, the ground electrode GND24 extends from a position that faces one of radiating elements 123 that are adjacent to each other in the X-axis direction to a position that faces the other one of the radiating elements 123 that are adjacent to each other in the X-axis direction and extends from a position that faces one of radiating elements 123 that are adjacent to each other in the Y-axis direction to a position that faces the other one of the radiating elements 123 that are adjacent to each other in the Y-axis direction.

The antenna module 100D corresponds to the arrangement in which the antenna elements 151 and 152 are arranged in a two-dimensional array and the ground electrodes GND22 in the antenna module 100B illustrated in FIG. 4 extend further in the longitudinal direction to be connected to one another. Thus, the surface area of the ground electrode GND24 is larger than that of the ground electrodes GND22. As a result, in the antenna module 100D according to the fifth embodiment, the antenna gain of the radiating elements 123 can further be improved.

The antenna elements 151 and 152 may be arranged in a houndstooth pattern when seen from the Z-axis direction. For example, in the case where the antenna elements 151 and 152 are arranged alternately with certain pitches therebetween in the first column, the second column, the third column, and so on in the X-axis direction, the positions in the Y-axis direction of the first antenna elements 151 in odd columns may be set to be the same, and the positions in the Y-axis direction of the first antenna elements 151 in even columns may be set to be different from the positions in the Y-axis direction of the first antenna elements 151 in the odd columns.

The configuration of the antenna module 100D is the same as the configuration of the antenna module 100 with the exception of the antenna elements 151 and 152 that are arranged in a two-dimensional array and the ground electrode GND24. Therefore, detailed description of the other configuration features of the antenna module 100D will not be repeated here.

### Sixth Embodiment

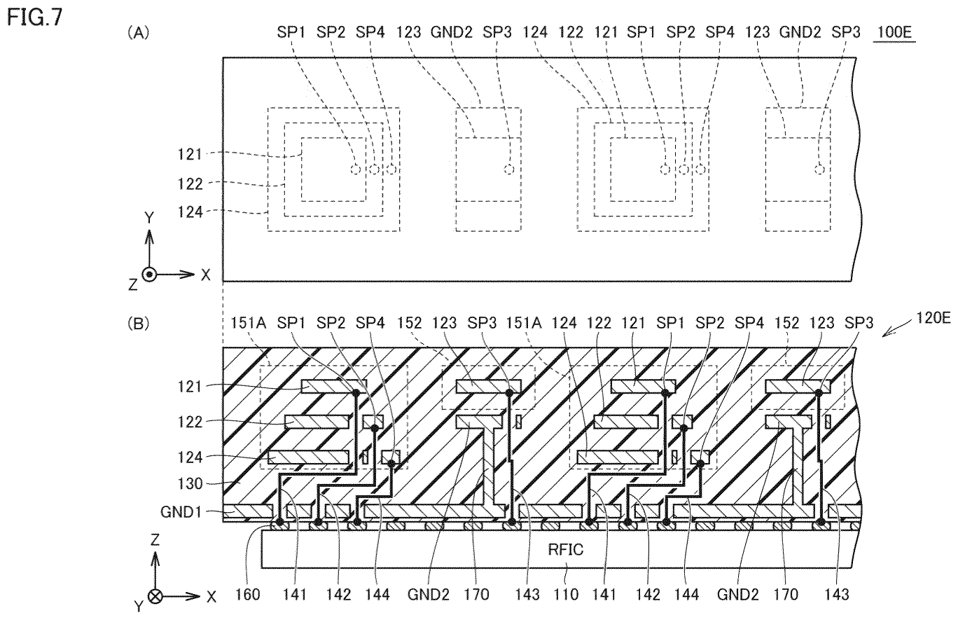

FIG. 7 includes a plan view and a side perspective view of an antenna module 100E according to a sixth embodiment. In FIG. 7, a plan view of the antenna module 100E is illustrated in an upper part (FIG. 7(A)), and a side perspective view of the antenna module 100E is illustrated in a lower part (FIG. 7(B)). The antenna module 100E includes the RFIC 110 and an antenna device 120E.

The antenna module 100E according to the sixth embodiment is different from the antenna module 100 according to the first embodiment in the number of radiating elements stacked in antenna elements that are adjacent to each other with an antenna element 152 interposed therebetween. In the antenna module 100E, as antenna elements that are adjacent to each other with an antenna element 152 interposed therebetween, antenna elements 151A each configuring a stacked patch antenna with a three-stage configuration are adopted.

As illustrated in FIG. 7, in the antenna element 151A, in addition to the radiating elements 121 and 122 as in the antenna elements 151, a radiating element 124 that is larger in size than the radiating element 122 is also stacked.

A high frequency signal is supplied from the RFIC 110 through a power feed wire 144 to the radiating element 124. The power feed wire 144 extends from the RFIC 110, penetrates through the ground electrode GND1, and is connected to a power feed point SP4 of the radiating element 124. The power feed point SP4 is offset in the X-axis positive direction from the center of the radiating element 124. A radio wave polarized in the X-axis direction in a frequency band lower than that of the radiating element 122 is radiated from the radiating element 124.

According to the sixth embodiment, the antenna module 100E, which is of a triple-band type, can be provided.

In the sixth embodiment, the radiating elements 124 are an example of fourth radiating elements. As illustrated in FIG. 7, in the X-axis direction, the size of the radiating elements 124 is larger than the size of the radiating elements 121 and is different from the size of the radiating elements 122. In this embodiment, the example in which, as an antenna element 151A, a radiating element 124 is provided between radiating elements 121 and 122 and the ground electrode GND1 has been described. However, an antenna element 151A may be configured such that a radiating element in a frequency band lower than the frequency band of a radiating element 121 and higher than the frequency band of a radiating element 122 is provided between the radiating element 121 and the radiating element 122. Furthermore, instead of a stacked patch antenna with a three-stage configuration, a stacked patch antenna with a four-stage or more-stage configuration may be used as the antenna element 151A.

The configuration of the antenna module 100E is the same as the configuration of the antenna module 100 with the exception of the antenna elements 151A. Therefore, detailed description of the other configuration features of the antenna module 100E will not be repeated here.

In the present disclosure, it may be intended to combine in an appropriate manner two or three or more of the embodiments described above.

[Aspects]

The embodiments described above are understood by those skilled in the art to be specific examples of aspects described below.

<1> An antenna module according to an aspect includes a dielectric substrate; a first ground electrode and a second ground electrode that are arranged at the dielectric substrate; a plurality of first antenna elements that are arranged in a first direction at the dielectric substrate; and a second antenna element that is arranged at the dielectric substrate. The plurality of first antenna elements face the first ground electrode in a second direction that is different from the first direction. The second antenna element faces the second ground electrode in the second direction. The second antenna element is arranged between first antenna elements that are adjacent to each other, among the plurality of first antenna elements, when seen from a third direction that is orthogonal to the first direction and the second direction. Each of the first antenna elements that are adjacent to each other includes a first radiating element and a second radiating element that is arranged between the first radiating element and the first ground electrode. The second antenna element includes a third radiating element. The first radiating element, the second radiating element, and the third radiating element each have a flat plate shape. In the first direction, a size of the second radiating element is larger than a size of the first radiating element. An opposing distance between the third radiating element and the second ground electrode is shorter than an opposing distance between the first radiating element and the first ground electrode.

<2> In the antenna module according to <1>, in the first direction, a size of the second ground electrode is smaller than a size of the third radiating element.

<3> In the antenna module according to <1> or <2>, in the third direction, a size of the second ground electrode is larger than the size of the second radiating element.

<4> In the antenna module according to any one of <1> to <3>, in the second direction, the first ground electrode and the second ground electrode face each other. When seen from the third direction, an opposing distance between the second radiating element and the first ground electrode is equal to or more than an opposing distance between the second ground electrode and the first ground electrode.

<5> In the antenna module according to any one of <1> to <4>, a plurality of second antenna elements are arranged at the dielectric substrate. The first antenna elements that are adjacent to each other and the second antenna element that is arranged between the first antenna elements that are adjacent to each other are arranged in an array in the first direction at the dielectric substrate.

<6> In the antenna module according to any one of <1> to <4>, a plurality of second antenna elements are arranged at the dielectric substrate. The first antenna elements that are adjacent to each other and the second antenna element that is arranged between the first antenna elements that are adjacent to each other are arranged in an array in the third direction at the dielectric substrate.

<7> In the antenna module according to <5>, the first antenna elements that are adjacent to each other and the second antenna element that is arranged between the first antenna elements that are adjacent to each other are arranged in an array also in the third direction at the dielectric substrate. The second ground electrode extends from a position that faces one of second antenna elements that are adjacent to each other in the first direction to a position that faces the other one of the second antenna elements that are adjacent to each other in the first direction and extends from a position that faces one of second antenna elements that are adjacent to each other in the third direction to a position that faces the other one of the second antenna elements that are adjacent to each other in the third direction.

<8> In the antenna module according to any one of <1> to <7>, in the second direction, the first ground electrode and the second ground electrode face each other. The second ground electrode includes a connection part that is connected to the first ground electrode with a via conductor interposed therebetween. A distance in the first direction between an end portion of the second ground electrode and the connection part is ¼ or more and ¾ or less the size in the first direction of the second radiating element.

<9> In the antenna module according to any one of <1> to <8>, a distance in the second direction between the first radiating element and the first ground electrode and a distance in the second direction between the third radiating element and the first ground electrode are the same.

<10> In the antenna module according to any one of <1> to <9>, in the first direction or the third direction, the size of the second radiating element is twice or more the size of the first radiating element.

<11> In the antenna module according to any one of <1> to <10>, in the first direction, the size of the first radiating element and the size of the third radiating element are the same.

<12> In the antenna module according to any one of <1> to <11>, the second radiating element radiates a radio wave in a first frequency band. The first radiating element and the third radiating element radiate radio waves in a second frequency band that is higher than the first frequency band.

<13> The antenna module according to any one of <1> to <12> further includes a fourth radiating element that faces the first ground electrode and is arranged between the first radiating element and the first ground electrode. In the first direction, a size of the fourth radiating element is larger than the size of the first radiating element and is different from the size of the second radiating element.

<14> A communication device according to another aspect is equipped with the antenna module according to any one of <1> to <13>.

The embodiments disclosed herein are to be considered in all respects to be illustrative and not restrictive. The scope of the present disclosure is defined by the claims, rather than the embodiments described above, and is intended to include all modifications within the meaning and scope equivalent to the scope of the claims.

### REFERENCE SIGNS LIST

10 communication device, 100 and 100A to 100E antenna module, 110 RFIC, 110A to 110C power feed circuit, 111A to 111D, 113A to 113D, and 117 switch, 112AR to 112DR low noise amplifier, 112AT to 112DT power amplifier, 114A to 114D attenuator, 115A to 115D phase shifter, 116 signal combiner/splitter, 118 mixer, 119 amplifier circuit, 120 and 120A to 120E antenna device, 121 to 124 radiating element, 130 dielectric substrate, 141 to 144 power feed wire, 151, 151A, and 152 antenna element, 160 solder bump, 200 BBIC, CP1 connection part, GND1, GND2, and GND21 to GND24 ground electrode, SP1 to SP4 power feed point.

1. An antenna module comprising:
a dielectric substrate;
a first ground electrode and a second ground electrode that are arranged at the dielectric substrate;
a plurality of first antenna elements that are arranged in a first direction at the dielectric substrate; and
a second antenna element that is arranged at the dielectric substrate,
wherein the plurality of first antenna elements face the first ground electrode in a second direction that is different from the first direction,
wherein the second antenna element faces the second ground electrode in the second direction,
wherein the second antenna element is arranged between first antenna elements that are adjacent to each other, among the plurality of first antenna elements, when seen from a third direction that is orthogonal to the first direction and the second direction,
wherein each of the first antenna elements that are adjacent to each other includes a first radiating element and a second radiating element that is arranged between the first radiating element and the first ground electrode,
wherein the second antenna element includes a third radiating element,
wherein the first radiating element, the second radiating element, and the third radiating element each have a flat plate shape,
wherein in the first direction, a size of the second radiating element is larger than a size of the first radiating element, and
wherein an opposing distance between the third radiating element and the second ground electrode is shorter than an opposing distance between the first radiating element and the first ground electrode.

2. The antenna module according to claim 1, wherein in the first direction, a size of the second ground electrode is smaller than a size of the third radiating element.

3. The antenna module according to claim 2, wherein in the third direction, a size of the second ground electrode is larger than the size of the second radiating element.

4. The antenna module according to claim 3,
wherein in the second direction, the first ground electrode and the second ground electrode face each other, and
wherein when seen from the third direction, an opposing distance between the second radiating element and the first ground electrode is equal to or more than an opposing distance between the second ground electrode and the first ground electrode.

5. The antenna module according to claim 4,
wherein a plurality of second antenna elements are arranged at the dielectric substrate, and
wherein the first antenna elements that are adjacent to each other and the second antenna element that is arranged between the first antenna elements that are adjacent to each other are arranged in an array in the first direction at the dielectric substrate.

6. The antenna module according to claim 4,
wherein a plurality of second antenna elements are arranged at the dielectric substrate, and
wherein the first antenna elements that are adjacent to each other and the second antenna element that is arranged between the first antenna elements that are adjacent to each other are arranged in an array in the third direction at the dielectric substrate.

7. The antenna module according to claim 5,
wherein the first antenna elements that are adjacent to each other and the second antenna element that is arranged between the first antenna elements that are adjacent to each other are arranged in an array also in the third direction at the dielectric substrate, and
wherein the second ground electrode extends from a position that faces one of second antenna elements that are adjacent to each other in the first direction to a position that faces the other one of the second antenna elements that are adjacent to each other in the first direction and extends from a position that faces one of second antenna elements that are adjacent to each other in the third direction to a position that faces the other one of the second antenna elements that are adjacent to each other in the third direction.

8. The antenna module according to claim 7,
wherein in the second direction, the first ground electrode and the second ground electrode face each other,
wherein the second ground electrode includes a connection part that is connected to the first ground electrode with a via conductor interposed therebetween, and
wherein a distance in the first direction between an end portion of the second ground electrode and the connection part is ¼ or more and ¾ or less the size in the first direction of the second radiating element.

9. The antenna module according to claim 8, wherein a distance in the second direction between the first radiating element and the first ground electrode and a distance in the second direction between the third radiating element and the first ground electrode are the same.

10. The antenna module according to claim 9, wherein in the first direction or the third direction, the size of the second radiating element is twice or more the size of the first radiating element.

11. The antenna module according to claim 10, wherein in the first direction, the size of the first radiating element and the size of the third radiating element are the same.

12. The antenna module according to claim 11,
wherein the second radiating element radiates a radio wave in a first frequency band, and
wherein the first radiating element and the third radiating element radiate radio waves in a second frequency band that is higher than the first frequency band.

13. The antenna module according to claim 12, further comprising:
a fourth radiating element that faces the first ground electrode and is arranged between the first radiating element and the first ground electrode,
wherein in the first direction, a size of the fourth radiating element is larger than the size of the first radiating element and is different from the size of the second radiating element.

14. A communication device equipped with the antenna module according to claim 13.

15. The antenna module according to claim 1,
wherein in the second direction, the first ground electrode and the second ground electrode face each other, and
wherein when seen from the third direction, an opposing distance between the second radiating element and the first ground electrode is equal to or more than an opposing distance between the second ground electrode and the first ground electrode.

16. The antenna module according to claim 15,
wherein a plurality of second antenna elements are arranged at the dielectric substrate, and
wherein the first antenna elements that are adjacent to each other and the second antenna element that is arranged between the first antenna elements that are adjacent to each other are arranged in an array in the first direction at the dielectric substrate.

17. The antenna module according to claim 15,
wherein a plurality of second antenna elements are arranged at the dielectric substrate, and
wherein the first antenna elements that are adjacent to each other and the second antenna element that is arranged between the first antenna elements that are adjacent to each other are arranged in an array in the third direction at the dielectric substrate.

18. The antenna module according to claim 17,
wherein the first antenna elements that are adjacent to each other and the second antenna element that is arranged between the first antenna elements that are adjacent to each other are arranged in an array also in the third direction at the dielectric substrate, and
wherein the second ground electrode extends from a position that faces one of second antenna elements that are adjacent to each other in the first direction to a position that faces the other one of the second antenna elements that are adjacent to each other in the first direction and extends from a position that faces one of second antenna elements that are adjacent to each other in the third direction to a position that faces the other one of the second antenna elements that are adjacent to each other in the third direction.

19. The antenna module according to claim 18,
wherein in the second direction, the first ground electrode and the second ground electrode face each other,
wherein the second ground electrode includes a connection part that is connected to the first ground electrode with a via conductor interposed therebetween, and
wherein a distance in the first direction between an end portion of the second ground electrode and the connection part is ¼ or more and ¾ or less the size in the first direction of the second radiating element.

20. The antenna module according to claim 19, wherein a distance in the second direction between the first radiating element and the first ground electrode and a distance in the second direction between the third radiating element and the first ground electrode are the same.
